(19) United States
(12) Patent Application Publication
(10) Pub. No.: US 2011/0161503 A1
(43) Pub. Date: Jun. 30, 2011

(54) METHOD AND SYSTEM FOR MULTIPLE PHYSICAL USE OF A SINGLE IDENTIFIER CODE SHARED BY A GROUP OF TERMINALS IN MOBILE TELECOMMUNICATIONS NETWORKS

(76) Inventor: Christian Krebs, Hohen Neuendorf (DE)

(21) Appl. No.: 13/058,319

(22) PCT Filed: Aug. 6, 2009
(86) PCT No.: PCT/EP2009/005705

§ 371 Date: Mar. 14, 2011

(30) Foreign Application Priority Data
Aug. 14, 2008 (DE) 10 2008 037 725.2

(51) Int. Cl. G06F 15/16

(52) U.S. Cl. 709/227

(57) ABSTRACT

A method for conducting communication between a plurality of terminals and at least one control center via a network, the terminals being combined into a group, with all the terminals in that group having the same identifier code within the network, and attachment to the network and establishment of a connection between an individual terminal and the control center taking place within a predetermined time window with subsequent terminating of the connection and detachment from the network, and attachment to the network and establishment of a connection between the next terminal in that group and the control center taking place within the following time window, so that after a predeterminable time period has elapsed all the terminals assigned to the group were or could have been connected to the control center at least once.

The invention relates to a method and a communications system for conducting communication between a multiplicity of terminals and at least one control center via a network.

Communication of this kind between a multiplicity of terminals and at least one control center takes place in particular in machine-to-machine communication, abbreviated in the following as M2M. M2M stands for the automated information exchange between terminals such as machines, automated equipment, vehicles, containers, or similar, and a central control point. This permits, for example, the remote monitoring, control and maintenance of measuring instruments, machines, plants and systems. In this respect, the communication is conducted in particular by using landline and mobile telephone connections.

There is a shortage of resources in mobile telephone networks. Up to the present, a separate identifier code (MSISDN/IMSI/IP address) has been used in mobile telephone networks. Utilization in mobile telephone networks has been mainly voice-driven. Each user must be uniquely identifiable.

In the future, utilization will be shifting more and more toward data applications and M2M. In this respect, almost every technical device can be equipped with an M2M module. This will lead to a vast number of M2M devices and hence of the required different identifier codes (MSISDN/IMSI/IP addresses) in mobile telephone networks or landline/telecommunications networks along with the associated usage of resources. In the M2M environment, in particular, small volumes of data are transmitted. As a result, economical operation of users/M2M modules will be rendered difficult or impossible, since vast capacities must be reserved for low usage rates.

The object of the invention is therefore to develop a method and a communications system for communication between a multiplicity of terminals and at least one control center in such a manner that the existing network resources are relieved and the required resource usage is minimized.

This object is achieved in accordance with the invention by a method as set forth in claim 1 and a communications system as set forth in claim 9. Further advantageous embodiments of the method according to the invention and of the system according to the invention are given in the dependent claims.

In the method according to the invention for conducting communication between a multiplicity of terminals and at least one control center via a network, it is particularly advantageous that the terminals are combined into a group, with all the terminals in that group having the same identifier code within the network and attachment and establishment of a connection between an individual terminal and the control center taking place within a predetermined time window (interval) with subsequent cutting of the connection and detachment from the network, and attachment to the network and establishment of a connection between the next terminal in that group and the control center taking place within the following time window, so that after a predeterminable time period has elapsed all the terminals assigned to the group could be connected to the control center at least once (but do not necessarily have to be so connected, as this can be controlled as required). This means that, since a corresponding time window was available for each individual terminal, all terminals assigned to the group have been connected, or at least could have been connected, to the control center via the network at least once within the time period, this being the case in particular when the establishment of a connection is initiated by the respective terminal as required.

In the communications system, which is suitable in particular for applying and using the method according to the invention and comprises a multiplicity of terminals and at least one control center, the terminals and the control center being capable of communicating with one another via a network, it is especially advantageous that a multiplicity of terminals are combined into a group, all the terminals in that group having the same identifier code within the network, and that a time management module is provided by means of which establishment of a connection between an individual terminal and the control center takes place within a predetermined time window with subsequent cutting of the connection, with the establishment of a connection between the next terminal in that group and the control center taking place within the following time window, so that after a predeterminable time period has elapsed all the terminals assigned to the group have been connected to the control center at least once.

In this respect, the term “establishment of a connection” does not refer merely to a pure connection as such, but also to the communication between the terminal and the control center as well as to the corresponding and possible data transfer, data polling and storage, etc.

The underlying idea of the invention is thus to use one single identifier code, for example an MSISDN/IMSI/IP address or similar, within the mobile telephone network, computer network or landline/telecommunications network for one single M2M module group comprising several users/M2M modules. For this purpose, all M2M modules in an M2M module group must attach to the network (mobile telephone network, computer network, Internet, landline/telecommunications network) at different times using one and the same identifier code (MSISDN/IMSI/IP address). Attachment must not take place simultaneously, but one after the other. In this respect, a time-slot procedure (e.g. based on the Modulo principle) could, for example, be used. This permits the multiple physical use of a single identifier code in telecommunications networks.

Preferably, the network is a mobile telephone network, a landline telephone network, a computer network, the Internet or a combination of several such similar and/or dissimilar networks. By using one or more network technologies and communication routes a large variety of different applications and M2M solutions can be achieved.

Preferably, the establishment of a connection between a terminal and the control center is initiated by the respective terminal. Such an establishment of a connection can take place according to a predetermined time schedule, but can, in particular, also be triggered as an alarm call. Alternatively, the establishment of a connection between a terminal and the control center is initiated by the control center.

In addition, establishment of a connection between a terminal and the control center can be initiated by the respective terminal as required, in particular as a function of definable parameters. This allows, for example, M2M solutions in which, by using M2M technology in the context of logistics or fleet management, establishment of a connection and data transfer takes place whenever, for example, a particular distance has been traveled or in the case of a departure from the planned route, or similar, the actual position being determined by means of navigation data, e.g. using satellite navigation, and transmitted to the control center.

In an especially preferred embodiment, a terminal and/or the control center can reserve additional connection time for a connection between the terminal and the control center, in particular through signaling by the terminal to the control center. In this way, an additional requirement for establishment of a connection can be signaled and taken into account.

Preferably, the time management of the individual connections to the terminals in the group is handled by the control center, i.e. a time management module is assigned to the control center.

Preferably, the terminals are mobile telephone terminals, each of which having a subscriber identification module, the subscriber identification modules of all terminals in a group being identical.

A determining factor is that each module in an M2M module group itself knows precisely when it can attach to the network and establish a connection and when the connection must be cut and the detachment procedure executed in order to allow the following module to establish a connection. In addition, a central unit knows precisely when a particular module of an M2M module group will establish the connection.

An individual M2M module of an M2M module group can either establish a connection or not, as required.

An individual M2M module of an M2M module group can signal that it requires additional time for a connection.

For such additional requests for connection, the central unit can reserve time (for example by keeping a defined time slot free for such requests).

For example, with 50 modules in an M2M module group and with hourly time periods, each individual module could be assigned a time slot of 1 minute, with a time reserve of 10 minutes being available for additional connection requests.

The definition of the number of M2M modules in an M2M module group as well as the length of the time slots must be performed in a suitable manner (by parameter setting) and can be changed dynamically.

Both the central unit and the M2M modules can initiate the establishment of a connection.

An essential aspect is that either the carriers (SIM cards) of the identifier code (MSISDN/IMSI/IP address) can be cloned and inserted into the M2M modules or that one and the same identifier code (MSISDN/IMSI/IP address) can be used in several M2M modules.

Technical modifications of the mobile telephone network are not necessarily required. The important thing is that multiple use of the identifier code (MSISDN/IMSI/IP address) is possible, e.g. by using cloned SIM cards.

1. A method for conducting communication between a multiplicity of terminals and at least one control center via a network in which the terminals are combined into a group, wherein all the terminals in that group having one and the same identifier code within the network and attachment to the network using this one and the same identifier code and establishment of a connection between an individual terminal and the control center taking place within a predetermined time window with subsequent cutting of the connection and detachment from the network, and within the following time window attachment to the network using this one and the same identifier code and establishment of a connection between the next terminal in that group and the control center taking place as required, so that after a predetermined time period has elapsed all the terminals assigned to the group were connected or could have been connected to the control center at least once.

2. The method according to claim 1, wherein the network is a mobile telephone network, a landline telephone network, a computer network or a combination of several such similar and/or dissimilar networks.

3. The method according to claim 1, wherein attachment to the network and establishment of a connection between a terminal and the control center is initiated by the respective terminal.

4. The method according to claim 1 wherein attachment to the network and establishment of a connection between a terminal and the control center is initiated by the control center.

5. The method according to claim 1, wherein attachment to the network and establishment of a connection between a terminal and the control center is initiated by the respective terminal as required as a function of definable parameters.

6. The method according to claim 1, wherein a terminal or the control center can reserve additional connection time for a connection between the terminal and the control center through signaling by the terminal to the control center.

7. The method according to claim 1, wherein the time management of the individual attachments to the network and connections to the terminals in the group is handled by the control center.

8. The method according to claim 1, wherein the terminals are mobile telephone terminals, each of which having a subscriber identification module, the subscriber identification modules of all terminals in a group being identical.

9. A communications system for carrying out the method of claim 1, the system comprising a multiplicity of terminals and at least one control center, the terminals and the control center being capable of communicating with one another via a network in which the multiplicity of terminals are combined into a group, wherein all the terminals in that group having one and the same identifier code within the network, and a to time management module is provided by which attachment to the network and establishment of a connection between an individual terminal and the control center takes place within a predetermined time window with subsequent cutting of the connection and detachment from the network with the establishment of a connection between the next terminal in that group and the control center taking place within the following time window as required, so that after a predeterminable time period has elapsed all the terminals assigned to the group have been connected or could have been connected to the control center at least once.

10. The system according to claim 9, wherein the terminals are mobile telephone terminals, each of which having a subscriber identification module, the subscriber identification modules of all terminals in a group being identical.

11. The system according to claim 9, wherein the time management module is assigned to the control center.

12. The system according to claim 9, wherein the network is a mobile telephone network, a landline telephone network, a computer network or a combination of several such similar or dissimilar networks.
